(19) United States
(12) Patent Application Publication
(10) Pub. No.: US 2022/0053179 A1
(43) Pub. Date: Feb. 17, 2022

(54) INFORMATION PROCESSING APPARATUS, INFORMATION PROCESSING METHOD, AND PROGRAM

(71) Applicant: SONY CORPORATION, TOKYO (JP)

(72) Inventor: HIROKI GOHARA, TOKYO (JP)

(21) Appl. No.: 17/274,378

(22) PCT Filed: Aug. 5, 2019
(86) PCT No.: PCT/JP2019/030670

§ 371 Date: Mar. 8, 2021

(30) Foreign Application Priority Data
Sep. 18, 2018 (JP) 2018-173767

(51) Int. Cl. H04N 13/275; H04N 5/232; H04N 13/178; H04N 13/106; H04N 13/282

(52) U.S. Cl. CPC H04N 13/275; H04N 5/23238; H04N 13/282; H04N 13/158; H04N 13/178

(57) ABSTRACT

An information processing apparatus according to an embodiment of the present technology includes a processor. The processor switches between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

### TECHNICAL FIELD

The present technology relates to an information processing apparatus, an information processing method, and a program that are applicable to display of, for example, a full 360-degree spherical video.

### BACKGROUND ART

Patent Literature 1 discloses an image processing apparatus in which, when a captured panoramic image is created, another captured image such as a moving image or a high-resolution image is attached to the captured panoramic image to be integrated with the captured panoramic image. This makes it possible to create a panoramic image that provides a greater sense of realism and a greater sense of immersion without imposing an excessive burden on a user (for example, paragraph [0075] of the specification in Patent Literature 1).

### CITATION LIST

### Patent Literature

Patent Literature 1: Japanese Patent Application Laid-open No. 2018-11302

### DISCLOSURE OF INVENTION

### Technical Problem

There is a need for a technology that can provide a high-quality viewing experience in, for example, a system that enables viewing of a panoramic video, a full 360-degree spherical video, and the like using, for example, a head-mounted display (HMD).

In view of the circumstances described above, it is an object of the present technology to provide an information processing apparatus, an information processing method, and a program that are capable of providing a high-quality viewing experience.

### Solution to Problem

In order to achieve the object described above, an information processing apparatus according to an embodiment of the present technology includes a processor.

The processor switches between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

In this information processing apparatus, switching processing corresponding to an angle of view of the first real space image is performed on the basis of metadata related to display switching, and switching is performed between display of the first real space image and display of the second real space image. This makes it possible to provide a high-quality viewing experience.

The processor may determine, on the basis of the metadata, whether the time has come to perform the switching processing, and the processor may perform the switching processing when the time has come to perform the switching processing.

The processor may determine, on the basis of the metadata, whether a switching condition for performing the switching processing is satisfied, and the processor may perform the switching processing when the switching condition is satisfied.

The switching condition may include a condition that a difference in image-capturing position between the first real space image and the second real space image is equal to or less than a specified threshold.

The switching condition may include a condition that a difference in image-capturing time between the first real space image and the second real space image is equal to or less than a specified threshold.

The switching processing may include generating a restriction image in which display on a range other than a corresponding range in the second real space image is restricted, the corresponding range corresponding to the angle of view of the first real space image; and switching between the display of the first real space image and display of the restriction image.

The switching processing may include changing a size of the first real space image such that the first real space image has a size of the corresponding range in the second real space image, and then switching between the display of the first real space image and the display of the restriction image.

The switching processing may include generating the restriction image such that display content displayed on the corresponding range in the restriction image and display content of the first real space image are the same display content.

The first real space image may be an image captured from a specified image-capturing position in a real space.

The second real space image may be an image obtained by combining a plurality of images captured from a specified image-capturing position in a real space.

The second real space image may be a full 360-degree spherical image.

The first real space image may be a moving image including a plurality of frame images. In this case, the processor may switch between display of a specified frame image from among the plurality of frame images of the first real space image and the display of the second real space image.

The second real space image may be a moving image including a plurality of frame images. In this case, the processor may switch between the display of the specified frame image of the first real space image and display of a specified frame image from among the plurality of frame images of the second real space image.

The metadata may include information regarding the angle of view of the first real space image.

The metadata may include first image-capturing information including an image-capturing position of the first real space image, and second image-capturing information including an image-capturing position of the second real space image.

The first image-capturing information may include an image-capturing direction and an image-capturing time of the first real space image. In this case, the second image-capturing information may include an image-capturing time of the second real space image.

The metadata may include information regarding a timing of performing switching processing.

The processor may control the display of the first real space image and the display of the second real space image on a head-mounted display (HMD).

An information processing method according to an embodiment of the present technology is an information processing method that is performed by a computer system, the information processing method including switching between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

A program according to an embodiment of the present technology causes a computer system to perform a process including switching between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed. Advantageous Effects of Invention

As described above, the present technology makes it possible to provide a high-quality viewing experience. Note that the effect described here is not necessarily limitative, and any of the effects described in the present disclosure may be provided.

### BRIEF DESCRIPTION OF DRAWINGS

FIG. 1 schematically illustrates an example of a configuration of a VR providing system according to an embodiment of the present technology.

FIG. 2 illustrates an example of a configuration of an HMD.

FIG. 3 is a block diagram illustrating an example of a functional configuration of the HMD.

FIG. 4 is a block diagram illustrating an example of a functional configuration of a server apparatus.

FIG. 5 is a schematic diagram for describing planar video data.

FIG. 6 schematically illustrates a planar video displayed by the HMD.

FIG. 7 is a schematic diagram for describing full 360-degree spherical video data.

FIG. 8 schematically illustrates a full 360-degree spherical video displayed by the HMD.

FIG. 9 illustrates an example of metadata.

FIG. 10 illustrates an example of the metadata.

FIG. 11 illustrates an example of the metadata.

FIG. 12 is a flowchart illustrating an example of processing of display switching from the full 360-degree spherical video to the planar video.

FIG. 13 is a flowchart illustrating an example of processing of display switching from the planar video to the full 360-degree spherical video.

FIG. 14 is a schematic diagram for describing an example of controlling the full 360-degree spherical video.

FIG. 15 is a schematic diagram for describing an example of controlling the planar video.

FIG. 16 schematically illustrates an example of how a video looks to a user when display switching processing is performed.

FIG. 17 schematically illustrates an example of a transition image.

FIG. 18 schematically illustrates an example of how a video looks to a user when display switching processing is performed.

FIG. 19 is a block diagram illustrating an example of a configuration of hardware of the server apparatus.

### MODE(S) FOR CARRYING OUT THE INVENTION

Embodiments according to the present technology will now be described below with reference to the drawings.

[Virtual Reality (VR) Providing System]

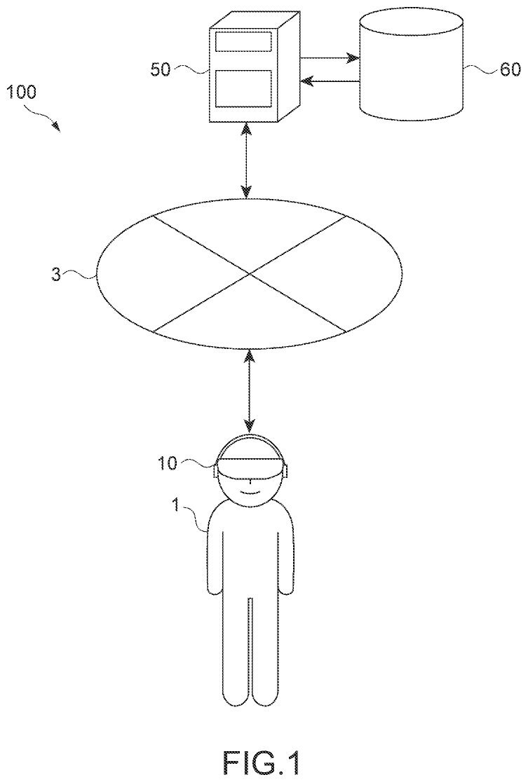

FIG. 1 schematically illustrates an example of a configuration of a VR providing system according to an embodiment of the present technology. A VR providing system 100 corresponds to an embodiment of an information processing system according to the present technology.

The VR providing system 100 includes an HMD 10 and a server apparatus 50.

The HMD 10 is used by being attached to the head of a user 1. The number of HMDs 10 included in the VR providing system 100 is not limited, although a single HMD 10 is illustrated in FIG. 1. In other words, the number of users 1 allowed to simultaneously participate in the VR providing system 100 is not limited.

The server apparatus 50 is communicatively connected to the HMD 10 through a network 3. The server apparatus 50 is capable of receiving various information from the HMD 10 through the network 3. Further, the server apparatus 50 is capable of storing various information in a database 60, and is capable of reading various information stored in the database 60 to transmit the read information to the HMD 10.

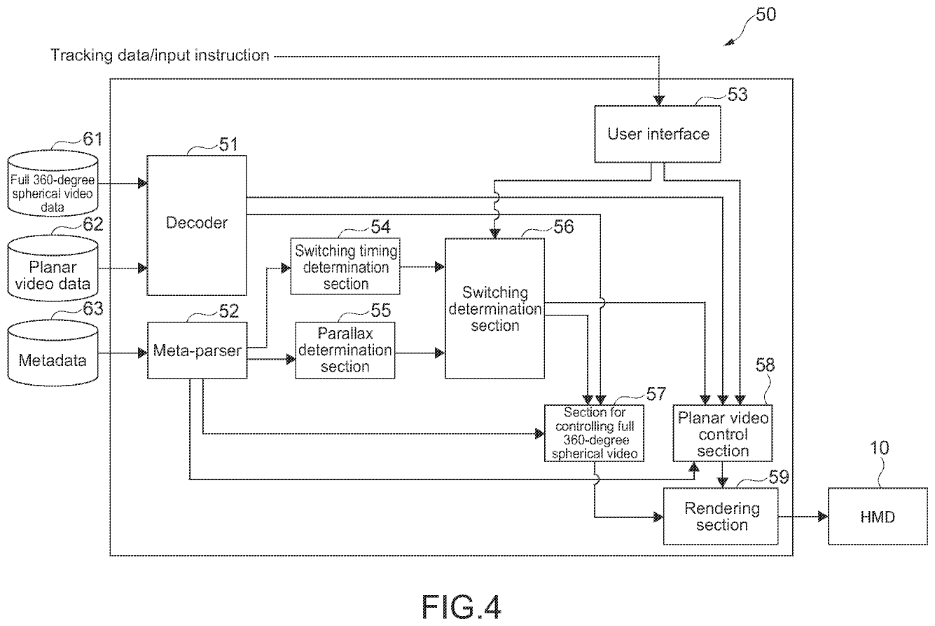

In the present embodiment, the database 60 stores therein full 360-degree spherical video data 61, planar video data 62, and metadata 63 (all of which are illustrated in FIG. 4). In the present embodiment, the server apparatus 50 transmits, to the HMD 10, content that includes display of a full 360-degree spherical video and display of a planar video. Further, the server apparatus 50 controls display of the full 360-degree spherical video and display of the planar video on the HMD 10. The server apparatus 50 serves as an embodiment of an information processing apparatus according to the present technology.

Note that, in the present disclosure, an “image” includes both a still image and a moving image. Further, the video is a concept included in a moving image. Thus, the “image” includes the video.

The network 3 is built using, for example, the Internet or a wide area communication network. Moreover, any wide area network (WAN), any local area network (LAN), or the like may be used, and the protocol used to build the network 3 is not limited.

In the present embodiment, so-called cloud services are provided by the network 3, the server apparatus 50, and the database 60. Thus, the HMD 10 is also considered to be connected to a cloud network.

Note that the method for communicatively connecting the server apparatus 50 and the HMD 10 is not limited. For example, the server apparatus 50 and the HMD 10 may be connected using near field communication such as Bluetooth (registered trademark) without building a cloud network.

[HMD]

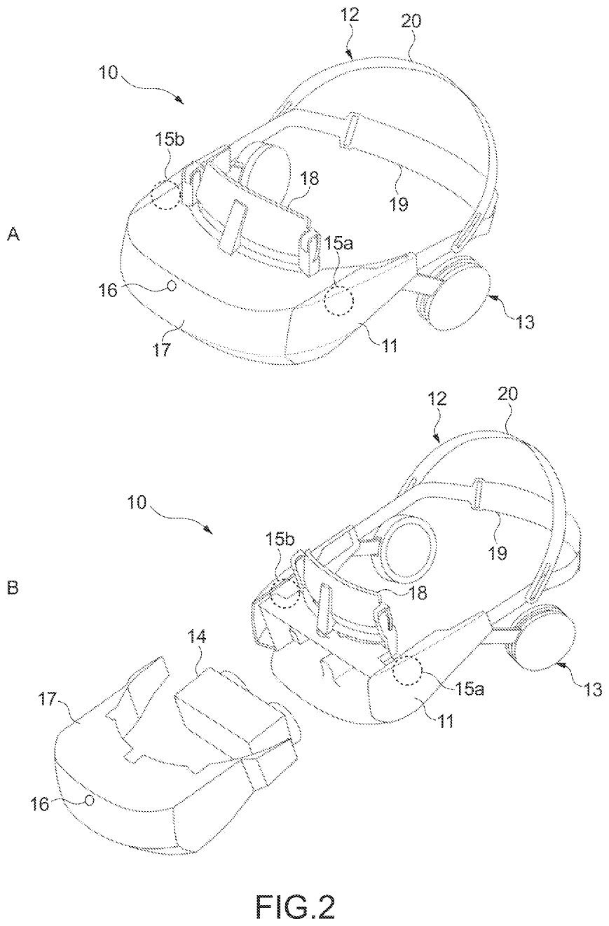

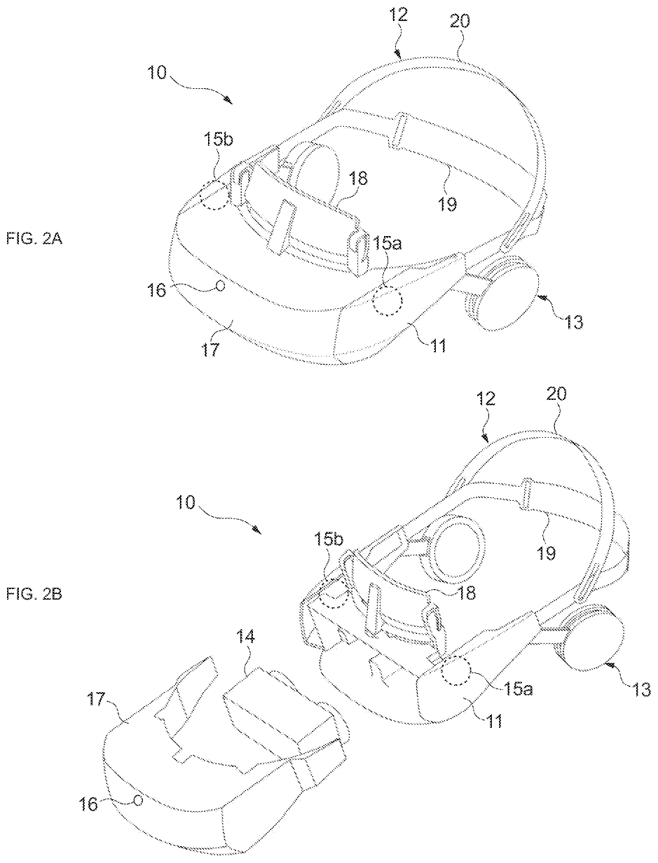

FIG. 2 illustrates an example of a configuration of the HMD 10. A of FIG. 2 is a schematic perspective view of an appearance of the HMD 10, and B of FIG. 2 is a schematic exploded perspective view of the HMD 10.

The HMD 10 includes a base 11, an attachment band 12, a headphone 13, a display unit 14, an inward-oriented camera 15 (15a, 15b), an outward-oriented camera 16, and a cover 17.

The base 11 is a member arranged in front of the right and left eyes of the user 1, and the base 11 is provided with a front-of-head support 18 that is brought into contact with the front of the head of the user 1.

The attachment band 12 is attached to the head of the user 1. As illustrated in FIG. 2, the attachment band 12 includes a side-of-head band 19 and a top-of-head band 20. The side-of-head band 19 is connected to the base 11, and is attached to surround the head of the user 1 from the side to the back of the head. The top-of-head band 20 is connected to the side-of-head band 19, and is attached to surround the head of the user 1 from the side to the top of the head.

The headphone 13 is connected to the base 11 and arranged to cover the right and left ears of the user 1. The headphone 13 includes right and left speakers. The position of the headphone 13 is manually or automatically controllable. The configuration for that is not limited, and any configuration may be adopted.

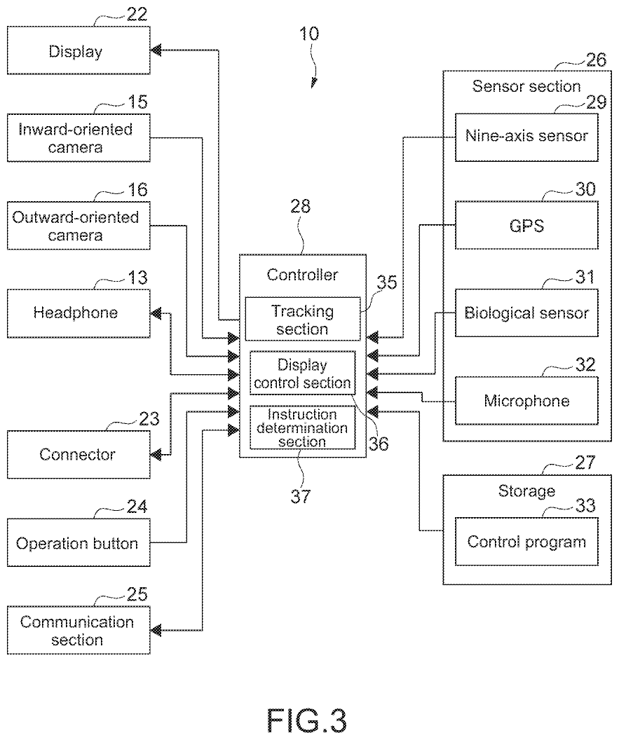

The display unit 14 is inserted into the base 11 and arranged in front of the eyes of the user 1. A display 22 (refer to FIG. 3) is arranged within the display unit 14. Any display device using, for example, a liquid crystal or an electroluminescence (EL) may be used as the display 22. Further, a lens system (of which an illustration is omitted) that guides an image displayed using the display 22 to the right and left eyes of the user 1 is arranged in the display unit 14.

The inward-oriented camera 15 includes a left-eye camera 15a and a right-eye camera 15b that are respectively capable of capturing images of the left eye and the right eye of the user 1. The left-eye camera 15a and the right-eye camera 15b are respectively arranged in specified positions in the HMD 10, specifically, in specified positions in the base 11. For example, it is possible to detect, for example, line-of-sight information regarding a line of sight of the user 1 on the basis of the images of the left eye and the right eye that are respectively captured by the left-eye camera 15a and the right-eye camera 15b.

A digital camera that includes, for example, an image sensor such as a complementary metal-oxide semiconductor (CMOS) sensor or a charge coupled device (CCD) sensor is used as the left-eye camera 15a and the right-eye camera 15b. Further, for example, an infrared camera that includes an infrared illumination such as an infrared LED may be used.

The outward-oriented camera 16 is arranged in a center portion of the cover 17 to be oriented outward (toward the side opposite to the user 1). The outward-oriented camera 16 is capable of capturing an image of a real space on a front side of the user 1. A digital camera that includes, for example, an image sensor such as a CMOS sensor or a CCD sensor is used as the outward-oriented camera 16.

The cover 17 is mounted on the base 11, and is configured to cover the display unit 14. The HMD 10 having such a configuration serves as an immersive head-mounted display configured to cover the field of view of the user 1. For example, a three-dimensional virtual space is displayed by the HMD 10. When the user wears the HMD 10, this results in providing, for example, a virtual reality (VR) experience to the user 1.

FIG. 3 is a block diagram illustrating an example of a functional configuration of the HMD 10. The HMD 10 further includes a connector 23, an operation button 24, a communication section 25, a sensor section 26, a storage 27, and a controller 28.

The connector 23 is a terminal used to establish a connection with another device. For example, a terminal such as a universal serial bus (USB) and a high-definition multimedia interface (HDMI) (registered trademark) is provided. Further, upon charging, a charging terminal of a charging dock (cradle) and the connector 23 are connected to perform charging.

The operation button 24 is provided at, for example, a specified position in the base 11. The operation button 24 makes it possible to perform an ON/OFF operation of a power supply, and an operation related to various functions of the HMD 10, such as a function related to display of an image and output of sound, and a function of a network communication.

The communication section 25 is a module used to perform network communication, near-field communication, or the like with another device. For example, a wireless LAN module such as Wi-Fi, or a communication module such as Bluetooth is provided. When the communication section 25 is operated, this makes it possible to perform wireless communication with the server apparatus 50.

The sensor section 26 includes a nine-axis sensor 29, a GPS 30, a biological sensor 31, and a microphone 32.

The nine-axis sensor 29 includes a three-axis acceleration sensor, a three-axis gyroscope, and a three-axis compass sensor. The nine-axis sensor 29 makes it possible to detect acceleration, angular velocity, and azimuth of the HMD 10 in three axes. The GPS 30 acquires information regarding the current position of the HMD 10. Results of detection performed by the nine-axis sensor 29 and the GPS 30 are used to detect, for example, the pose and the position of the user 1 (the HMD 10), and the movement (motion) of the user 1. These sensors are provided at, for example, specified positions in the base 11.

The biological sensor 31 is capable of detecting biological information regarding the user 1. For example, a brain wave sensor, a myoelectric sensor, a pulse sensor, a perspiration sensor, a temperature sensor, a blood flow sensor, a body motion sensor, and the like are provided as the biological sensor 31.

The microphone 32 detects information regarding sound around the user 1. For example, a voice from speech of the user is detected as appropriate. This enables the user 1 to, for example, enjoy VR experience while making a voice call and perform input of an operation of the HMD 10 using voice input.

The type of sensor provided as the sensor section 26 is not limited, and any sensor may be provided. For example, a temperature sensor, a humidity sensor, or the like that is capable of measuring a temperature, humidity, or the like of the environment in which the HMD 10 is used may be provided. The inward-oriented camera 15 and the outward-oriented camera 16 can also be considered a portion of the sensor section 26.

The storage 27 is a nonvolatile storage device, and, for example, a hard disk drive (HDD), a solid state drive (SSD), or the like is used. Moreover, any non-transitory computer readable storage medium may be used.

The storage 27 stores therein a control program 33 used to control an operation of the overall HMD 10. The method for installing the control program 33 on the HMD 10 is not limited.

The controller 28 controls operations of the respective blocks of the HMD 10. The controller 28 is configured by hardware, such as a CPU and a memory (a RAM and a ROM), that is necessary for a computer. Various processes are performed by the CPU loading, into the RAM, the control program 33 stored in the storage 27 and executing the control program 33.

For example, a programmable logic device (PLD) such as a field programmable gate array (FPGA), or other devices such as an application specific integrated circuit (ASIC) may be used as the controller 28.

In the present embodiment, a tracking section 35, a display control section 36, and an instruction determination section 37 are implemented as functional blocks by the CPU of the controller 28 executing a program (such as an application program) according to the present embodiment. Then, the information processing method according to the present embodiment is performed by these functional blocks. Note that, in order to implement each functional block, dedicated hardware such as an integrated circuit (IC) may be used as appropriate.

The tracking section 35 performs head tracking for detecting the movement of the head of the user 1, and eye tracking for detecting a side-to-side movement of a line of sight of the user 1. In other words, the tracking section 35 makes it possible to detect in which direction the HMD 10 is oriented and in which direction the line of sight of the user 1 is oriented. Data of tracking detected by the tracking section 35 is included in information regarding a pose of the user 1 (the HMD 10) and information regarding a line of sight of the user 1 (the HMD 10).

The head tracking and the eye tracking are calculated on the basis of a result of detection performed by the sensor section 26 and images captured by the inward-oriented camera 15 and the outward-oriented camera 16. The algorithm used to perform the head tracking and the eye tracking is not limited, and any algorithm may be used. Any machine-learning algorithm using, for example, a deep neural network (DNN) may be used. For example, it is possible to improve the tracking accuracy by using, for example, artificial intelligence (AI) that performs deep learning.

The display control section 36 controls an image display performed using the display unit 14 (the display 22). The display control section 36 performs, for example, image processing and a display control as appropriate. In the present embodiment, rendering data used to display an image on the display 22 is transmitted to the HMD 10 by the server apparatus 50. The display control section 36 performs image processing and a display control on the basis of the rendering data transmitted by the server apparatus 50, and displays the image on the display 22.

The instruction determination section 37 determines an instruction that is input by the user 1. For example, the instruction determination section 37 determines the instruction of the user 1 on the basis of an operation signal generated in response to an operation performed on the operation button 24. Further, the instruction determination section 37 determines the instruction of the user 1 on the basis of a voice of the user 1 that is input through the microphone 32.

Further, for example, the instruction determination section 37 determines the instruction of the user 1 on the basis of a gesture that is given using the hand or the like of the user 1 and of which an image is captured by the outward-oriented camera 16. Furthermore, it is also possible to determine the instruction of the user 1 on the basis of the movement of a line of sight of the user 1. Of course, the determination of the instruction is not limited to being performed when it is possible to perform all of voice input, gesture input, and input using the movement of a line of sight. Moreover, another method for inputting an instruction may also be performed.

A specific algorithm used to determine an instruction input by the user 1 is not limited, and any technique may be used. Further, any machine-learning algorithm may also be used.

[Server Apparatus]

FIG. 4 is a block diagram illustrating an example of a functional configuration of the server apparatus 50.

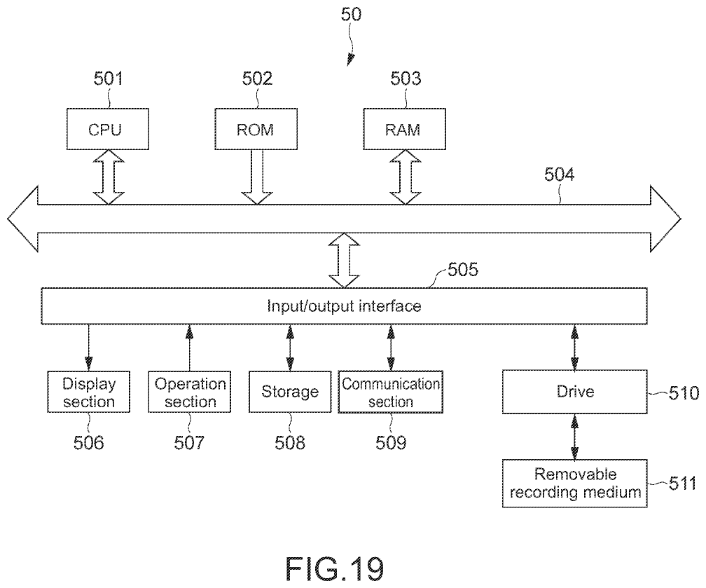

The server apparatus 50 includes hardware, such as a CPU, a ROM, a RAM, and an HDD, that is necessary for a configuration of a computer (refer to FIG. 19). A decoder 51, a meta-parser 52, a user interface 53, a switching timing determination section 54, a parallax determination section 55, a switching determination section 56, a section 57 for controlling a full 360-degree spherical video, a planar video control section 58, and a rendering section 59 are implemented as functional blocks by the CPU loading, into the RAM, a program according to the present technology that has been recorded in the ROM or the like and executing the program, and this results in the information processing method according to the present technology being performed.

The server apparatus 50 can be implemented by any computer such as a personal computer (PC). Of course, hardware such as an FPGA or an ASIC may be used. In order to implement each block illustrated in FIG. 4, dedicated hardware such as an integrated circuit (IC) may be used.

The program is installed on the server apparatus 50 through, for example, various recording media. Alternatively, the installation of the program may be performed via, for example, the Internet.

The decoder 51 decodes the full 360-degree spherical video data 61 and the planar video data 62 that are read from the database 60. The decoded full 360-degree spherical video data 61 is output to the section 57 for controlling a full 360-degree spherical video. The decoded planar video data 62 is output to the planar video control section 58. Note that encode/decode formats and the like for image data are not limited.

The meta-parser 52 reads metadata 63 from the database 60 and outputs the read metadata 63 to the switching timing determination section 54 and the parallax determination section 55. The metadata 63 is metadata related to switching between display of a full 360-degree spherical video and display of a planar video, and will be described in detail later.

The user interface 53 receives tracking data transmitted from the HMD 10 and an instruction input by the user 1. The received tracking data and input instruction are output as appropriate to the switching determination section 56 and the planar video control section 58.

The switching timing determination section 54, the parallax determination section 55, the switching determination section 56, the section 57 for controlling a full 360-degree spherical video, the planar video control section 58, and the rendering section 59 are blocks used to perform display switching processing according to the present technology. The display switching processing according to the present technology is processing performed to switch between display of a full 360-degree spherical video (a full 360-degree spherical image) and display of a planar video (a planar image), and corresponds to switching processing.

In the present embodiment, an embodiment of a processor according to the present technology is implemented by functions of the switching timing determination section 54, the parallax determination section 55, the switching determination section 56, the section 57 for controlling a full 360-degree spherical video, the planar video control section 58, and the rendering section 59. Thus, it can also be said that an embodiment of the processor according to the present technology is implemented by hardware, such as a CPU, that configures a computer. The respective blocks that are the switching timing determination section 54 and the others will be described together with the display switching processing described later.

Note that the server apparatus 50 includes a communication section (refer to FIG. 19) used to perform network communication, near-field communication, or the like with another device. When the communication section is operated, this makes it possible to perform wireless communication with the HMD 10.

[Planar Video]

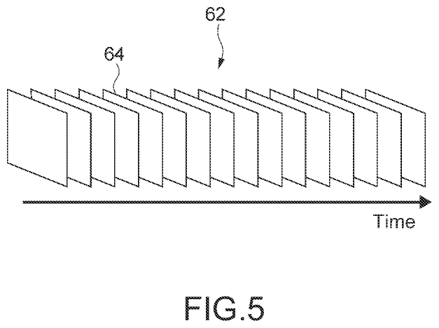

FIG. 5 is a schematic diagram for describing planar video data. The planar video data 62 is data of a moving image that includes a plurality of frame images 64.

An image (a video) and image data (video data) may be interchangeably described below. For example, when those are denoted by reference numerals to be described, a planar video 62 may be described using the same reference numeral as the planar video data 62.

In the present embodiment, a moving image is captured from a specified image-capturing position in a specified real space in order to create desired VR content. In other words, in the present embodiment, the planar video 62 is generated using a real space image that is an image of a real space. Further, in the present embodiment, the planar video 62 corresponds to a rectangle-shaped video of a real space that is captured using perspective projection.

The specified real space is a real space that is selected to obtain a virtual space, and any place such as indoor places including, for example, a stadium and a concert hall, and outdoor places including, for example, a mountain and a river, may be selected. The image-capturing position is also selected as appropriate. For example, any image-capturing position such as an entrance of a stadium, a specified auditorium, an entrance of a mountain trail, and a top of a mountain, may be selected.

In the present embodiment, the rectangular frame image 64 is generated by performing image-capturing at a specified aspect ratio and a specified resolution. The plurality of frame images 64 is captured at a specified frame rate to generate the planar video 62. The frame image 64 of the planar video 62 is hereinafter referred to as a planar frame image 64.

For example, a full HD image with 1920 pixels in width and 1080 pixels in height that has an aspect ratio of 16:9, is captured at 60 frames per second. Of course, the planar frame image 64 is not limited to this, and the aspect ratio, the resolution, the frame rate, and the like of the planar frame image 64 may be set discretionarily. Further, the shape of the planar video 62 (the planar frame image 64) is not limited to a rectangular shape. The present technology is also applicable to an image having another shape such as a circle or a triangle.

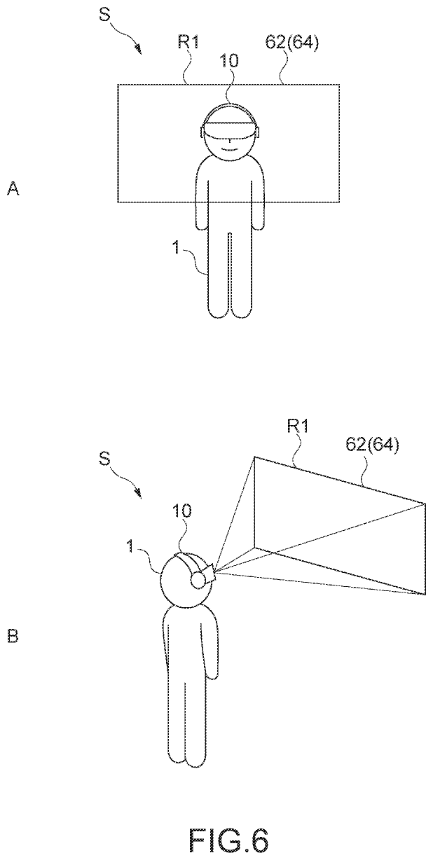

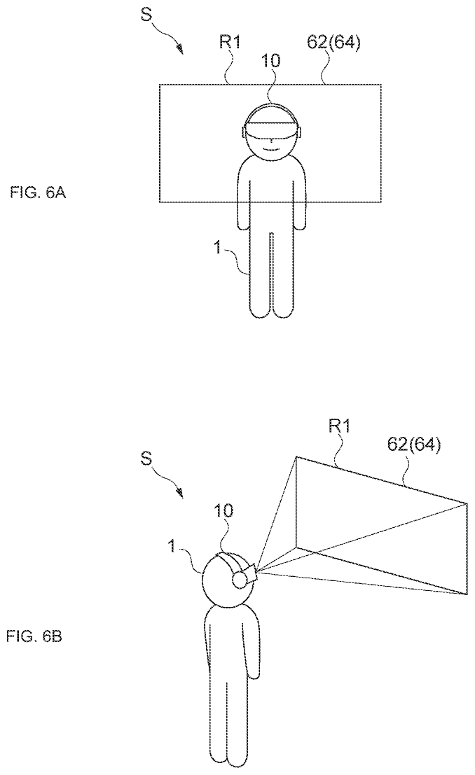

FIG. 6 schematically illustrates the planar video 62 displayed by the HMD 10. A of FIG. 6 illustrates the user 1 who is looking at the planar video 62 as viewed from the front (from the side of the planar video 62). B of FIG. 6 illustrates the user 1 who is looking at the planar video 62 as viewed from the diagonally rear of the user 1.

In the present embodiment, a space covering the complete 360 degrees circumference of the user 1 who is wearing the HMD 10, from back and forth, from side to side, and up and down, is a virtual space S represented by VR content. In other words, the user 1 is looking at a region in the virtual space S when the user 1 faces any direction around the user 1.

As illustrated in FIG. 6, the planar video 62 (the planar frame image 64) is displayed on the display 22 of the HMD 10. For the user 1 who is wearing the HMD 10, the planar video 62 is displayed on a region that is a portion of the virtual space S. The region, in the virtual space S, on which the planar video 62 is displayed is hereinafter referred to as a first display region R1.

For example, the planar video 62 is displayed on the front of the user 1. Thus, the position of the first display region R1 on which the planar video 62 is displayed can be changed according to, for example, the movement of the head of the user 1. Of course, it is also possible to adopt a display method that includes displaying the planar video 62 at a specified position in a fixed manner, which does not allow the user 1 to view the planar video 62 unless the user 1 looks in that direction.

Further, the size and the like of the planar video 62 can be changed by, for example, an instruction being given by the user 1. When the size of the planar video 62 is changed, the size of the first display region R1 is also changed. Note that, for example, in the virtual space S, a background image or the like is displayed on a region other than the first display region R1 on which the planar video 62 is displayed. The background image may be a homochromatic image such as a black or green image, or may be an image related to content. The background image may be generated using, for example, three-dimensional or two-dimensional CG.

In the present embodiment, the planar video 62 (the planar frame image 64) corresponds to a first real space image displayed on a virtual space. Further, the planar video 62 (the planar frame image 64) corresponds to an image captured from a specified image-capturing position in a real space. Note that the planar video 62 can also be referred to as an image having a specified shape. In the present embodiment, a rectangular shape is adopted as the specified shape, but another shape such as a circular shape may be adopted as the specified shape.

[Full 360-Degree Spherical Video]

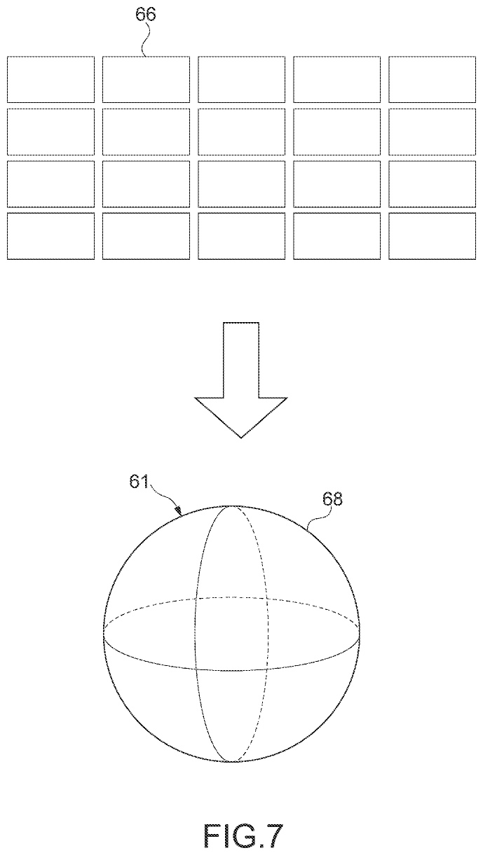

FIG. 7 is a schematic diagram for describing full 360-degree spherical video data. In the present embodiment, a plurality of real space images 66 is captured from a specified image-capturing position in a specified real space. The plurality of real space images 66 is captured in different image-capturing directions from the same image-capturing position so as to cover a real space covering the complete 360 degrees circumference from back and forth, from side to side, and up and down. Further, the plurality of real space images 66 is captured such that the angles of view (the image-capturing ranges) of adjacent captured images overlap.

When the plurality of real space images 66 is combined on the basis of a specified format, this results in generating the full 360-degree spherical video data 61 illustrated in FIG. 7. In the present embodiment, the plurality of real space images 66 captured using perspective projection is combined on the basis of a specified format. Examples of a format used to generate the full 360-degree spherical video data 61 include equirectangular projection and a cubemap. Of course, the format is not limited to this, and any projection method or the like may be used. Note that FIG. 7 merely schematically illustrates the full 360-degree spherical video data 61.

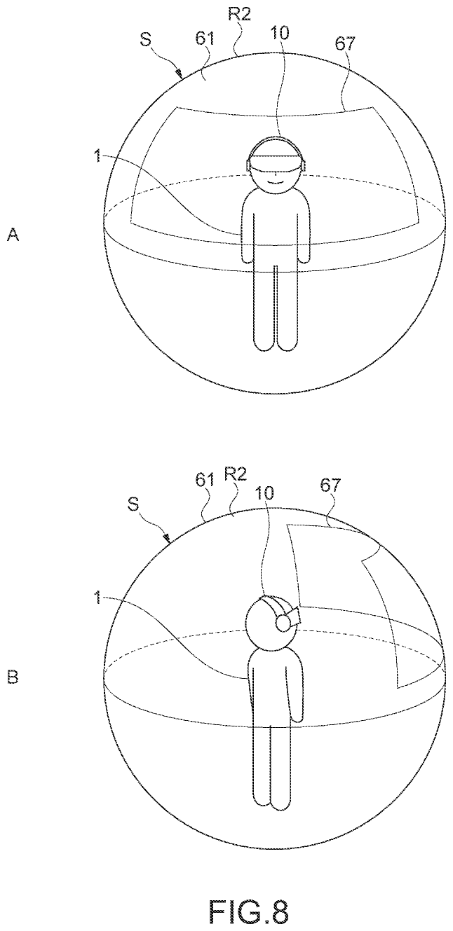

FIG. 8 schematically illustrates the full 360-degree spherical video 61 displayed by the HMD 10. A of FIG. 8 illustrates the user 1 who is looking at the full 360-degree spherical video 61 as viewed from the front. B of FIG. 8 illustrates the user 1 who is looking at the full 360-degree spherical video 61 as viewed from the diagonally rear of the user 1.

In the present embodiment, the full 360-degree spherical video data 61 is attached to a sphere virtually arranged around the HMD 10 (the user 1). Thus, for the user 1 who is wearing the HMD 10, the full 360-degree spherical video 61 is displayed on an entire region of the virtual space S covering the complete 360 degrees circumference from back and forth, from side to side, and up and down. This results in being able to provide a considerably great sense of immersion into content, and to provide the user 1 with an excellent viewing experience.

The region, in the virtual space S, on which the full 360-degree spherical video 61 is displayed is referred to as a second display region R2. The second display region R2 is all of the region in the virtual space S around the user 1. Compared with the first display region R1 on which the planar video 62 illustrated in FIG. 6 is displayed, the second display region R2 is a region that includes the first display region R1 and is larger than the first display region R1.

FIG. 8 illustrates a display region 67 of the display 22. A range in the full 360-degree spherical video 61 that can be viewed by the user 1 is a range corresponding to the display region 67 of the display 22. The position of the display region 67 of the display 22 is changed according to, for example, the movement of the head of the user 1, and the viewable range in the full 360-degree spherical video 61 is changed. This enables the user 1 to view the full 360-degree spherical video 61 in all directions.

Note that, in FIG. 8, the display region 67 of the display 22 has a shape along an inner peripheral surface of a sphere. Actually, a rectangular image similar to the planar video 62 illustrated in FIG. 6 is displayed on the display 22. A visual effect of covering the surroundings of the user 1 is provided to the user 1.

In the present disclosure, a display region of an image in the virtual space S refers to a region, in the virtual space S, on which the image is to be displayed, and not a region corresponding to a range actually displayed by the display 22. Thus, the first display region R1 is a rectangular region corresponding to the planar video 62 in the virtual space S. The second display region R2 is an entire region of the virtual space S that corresponds to the full 360-degree spherical video 61 and covers the complete 360 degrees circumference from back and forth, from side to side, and up and down.

Further, in the present embodiment, moving images each including a plurality of frame images are captured as the plurality of real space images 66 illustrated in FIG. 7. Then, for example, the corresponding frame images are combined to generate the full 360-degree spherical video 61. Accordingly, in the present embodiment, it is possible to view the full 360-degree spherical video 61 in the form of a moving image.

For example, the plurality of real space images 66 (moving images) is simultaneously captured in all directions. Then, the corresponding frame images are combined to generate the full 360-degree spherical video 61. Without being limited thereto, another method may be used.

Full 360-degree spherical images (still images) that are included in the full 360-degree spherical video 61 in the form of a moving image and sequentially displayed along a time axis, are frame images of the full 360-degree spherical video 61. The frame rate and the like of the frame image of the full 360-degree spherical video is not limited, and may be set discretionarily. As illustrated in FIG. 7, the frame image of the full 360-degree spherical video 61 is referred to as a full 360-degree spherical frame image 68.

Note that the size of the full 360-degree spherical video 61 (the full 360-degree spherical frame image 68) as viewed from the user 1 remains unchanged. For example, the scale of the full 360-degree spherical video 61 (the scale of a virtually set sphere) is changed centering on the user 1. In this case, the distance between the user 1 and the full 360-degree spherical video 61 (the inner peripheral surface of the virtual sphere) is also changed according to the change in scale, and this results in the size of the full 360-degree spherical video 61 remaining unchanged.

In the present embodiment, the full 360-degree spherical video 61 corresponds to a second real space image displayed on a region that includes a region, in a virtual space, on which the first real space image is displayed, the region on which the second real space image is displayed being larger than the region on which the first real space image is displayed. Further, the full 360-degree spherical video 61 corresponds to an image obtained by combining a plurality of images captured from a specified image-capturing position in a real space. Note that the full 360-degree spherical video 61 can also be referred to as a virtual reality video.

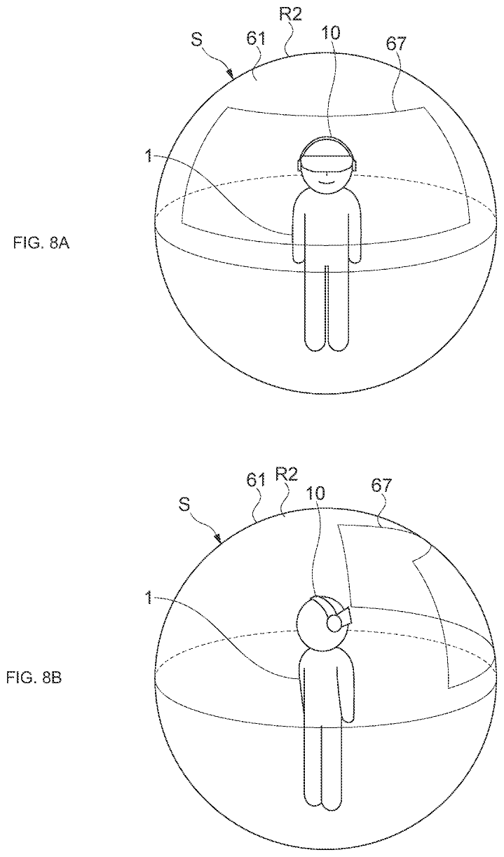

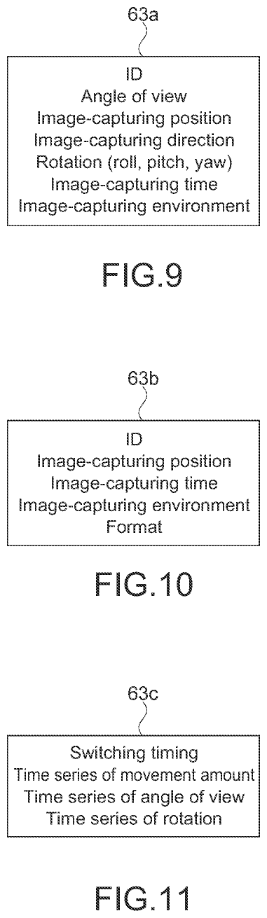

FIGS. 9 to 11 illustrate examples of the metadata 63. The metadata 63 is metadata related to switching between display of the planar video 62 and display of the full 360-degree spherical video 61. As illustrated in, for example, FIG. 9, metadata 63a related to the planar video 62 is stored. In the example illustrated in FIG. 9, information indicated below is stored as the metadata 63a.

ID: identification information given for each planar frame image 64

Angle of view: angle of view of the planar frame image 64

Image-capturing position: image-capturing position of the planar frame image 64

Image-capturing direction: image-capturing direction of the planar frame image 64

Rotation (roll, pitch, yaw): rotation position (rotation angle) of the planar frame image 64

Image-capturing time: date and time upon capturing the planar frame image 64

Image-capturing environment: image-capturing environment upon capturing the planar frame image 64

For example, the angle of view of the planar frame image 64 is determined by, for example, the angle of view and the focal length of a lens of an image-capturing apparatus used to capture the planar frame image 64. The angle of view of the planar frame image 64 can also be considered a parameter corresponding to an image-capturing range of the planar frame image 64. Thus, information regarding an image-capturing range of the planar frame image 64 may be stored as the metadata 63a. In the present embodiment, the angle of view of the planar frame image 64 corresponds to information regarding an angle of view of the first real space image.

The image-capturing position, the image-capturing direction, and the rotation position of the planar frame image 64 are determined by, for example, a specified XYZ coordinate system defined in advance. For example, an XYZ coordinate value is stored as the image-capturing position. A direction of an image-capturing optical axis of an image-capturing apparatus used to capture the planar frame image 64 is stored as the image-capturing direction using the XYZ coordinate value based on the image-capturing position. For example, a pitch angle, a roll angle, and a yaw angle when an X-axis is a pitch axis, a Y-axis is a roll axis, and a Z-axis is a yaw axis are stored as the rotation position. Of course, the present technology is not limited to the case in which such data is generated.

The date and time when the planar frame image 64 is captured is stored as the image-capturing time. Examples of the image-capturing environment include weather upon capturing the planar frame image 64. The type of the metadata 63a related to the planar video 62 is not limited. Further, there is also no limitation on the fact that each piece of information is to be stored in the form of what type of data.

In the present embodiment, the metadata 63a related to the planar video 62 corresponds to first image-capturing information. Of course, other information may be stored as the first image-capturing information.

Further, as illustrated in FIG. 10, metadata 63b related to the full 360-degree spherical video 61 is stored. In the example illustrated in FIG. 10, information indicated below is stored as the metadata 63b.

ID: identification information given for each full 360-degree spherical frame image 68

Image-capturing position: image-capturing position of the full 360-degree spherical frame image 68

Image-capturing time: date and time upon capturing the full 360-degree spherical frame image 68

Image-capturing environment: image-capturing environment upon capturing the full 360-degree spherical frame image 68

Format: format for the full 360-degree spherical video 61

The image-capturing position of the full 360-degree spherical frame image 68 is generated on the basis of the respective image-capturing positions of the plurality of real space images 66 illustrated in FIG. 7. Typically, the plurality of real space images 66 is captured at the same image-capturing position. Thus, that image-capturing position is stored. For example, an average of the respective image-capturing positions or the like is stored when the real space images 66 of the plurality of real space images 66 are captured in a state of being slightly offset with respect to one another.

The image-capturing time of the full 360-degree spherical frame image 68 is generated on the basis of the respective image-capturing times of the plurality of real space images 66 illustrated in FIG. 7. When the plurality of real space images 66 is captured at the same time, that image-capturing time is stored. When the real space images 66 of the plurality of real space images 66 are captured at different timings, a middle time from among the respective image-capturing times is stored.

Examples of the image-capturing environment include weather upon capturing the plurality of real space images 66. The format is a format used to generate the full 360-degree spherical video data 61 from the plurality of real space images 66. The type of the metadata 63b related to the full 360-degree spherical video 61 is not limited. Further, there is also no limitation on the fact that each piece of information is to be stored in the form of what type of data.

In the present embodiment, the metadata 63b related to the full 360-degree spherical video 61 corresponds to second image-capturing information. Of course, other information may be stored as the second image-capturing information.

FIG. 11 is an example of metadata 63c used to perform display switching processing in the present embodiment. In the example illustrated in FIG. 11, information indicated below is stored as the metadata 63c.

Switching timing: timing at which display switching processing is to be performed

Time series of movement amount: time series of a movement amount of the planar video 62 with respect to the full 360-degree spherical video 61

Time series of angle of view: time series of an angle of view of the planar video 62 with respect to the full 360-degree spherical video 61

Time series of image-capturing direction: time series of an image-capturing direction of the planar video 62 with respect to the full 360-degree spherical video 61

Time series of rotation: time series of a rotation position (a rotation angle) of the planar video 62 with respect to the full 360-degree spherical video 61

The switching timing is determined by, for example, a creator of VR content. For example, a timing at which the user 1 moves to a specified position in a virtual space and looks in a specified direction is stored. Alternatively, for example, a timing at which a specified period of time has elapsed since the start of VR content is stored. Moreover, various timings may be stored as the switching timings. In the present embodiment, the switching timing corresponds to information regarding a timing of performing switching processing.

The time series of a movement amount corresponds to time-series information regarding a difference (a distance) in image-capturing position between the planar frame image 64 and the full 360-degree spherical frame image 68. The time series of a movement amount makes it possible to calculate a difference in image-capturing position between the planar frame image 64 captured at a certain image-capturing time and the full 360-degree spherical frame image 68 captured at the certain image-capturing time. The difference in image-capturing position may be hereinafter referred to as parallax.

The time series of an angle of view, an image-capturing direction, and a rotation position of the planar video 62 with respect to the full 360-degree spherical video 61 corresponds to time-series information regarding a size and a position of a display region of the planar video 62 with respect to the full 360-degree spherical video 61. In other words, it can also be considered time-series information regarding a position and a size of the first display region R1 on which the planar video 62 is displayed with respect to the second display region R2 on which the full 360-degree spherical video 61 is displayed. It is possible to calculate, using this time-series information, a positional relationship (including the size) between the second display region R2 and the first display region R1 at a certain time.

The method including generating each piece of time-series information included in the metadata 63c and storing the generated piece of time-series information is not limited. For example, each piece of time-series information may be generated as appropriate and manually input by a creator of VR content. Alternatively, each piece of time-series information may be generated on the basis of the metadata 63a and the metadata 63b respectively illustrated in FIGS. 9 and 10, and may be stored as the metadata 63c. Further, it is also possible to generate each piece of time-series information using the technology disclosed in Patent Literature 1 described above (Japanese Patent Application Laid-open No. 2018-11302).

In the present embodiment, the time series of an angle of view can also be considered information regarding an angle of view of the first real space image. Further, it is also possible to use the time series of a movement amount, the time series of an image-capturing direction, and the time series of rotation as the first image-capturing information and the second image-capturing information.

The type of the metadata 63c is not limited. Further, there is also no limitation on the fact that each piece of information is to be stored in the form of what type of data. Note that it is also possible to generate each piece of time-series information in real time during playback of VR content, and to use the generated piece of time-series information to perform display switching processing, without storing the piece of time-series information as the metadata 63c.

[Display Switching Between Full 360-Degree Spherical Video and Planar Video]

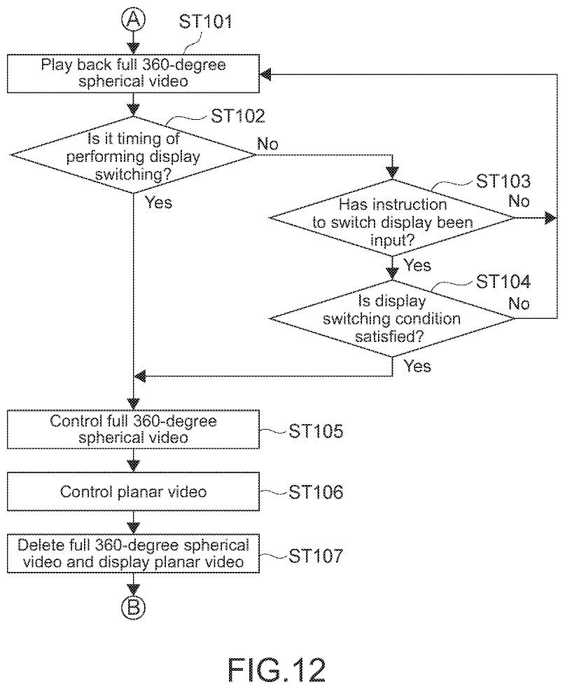

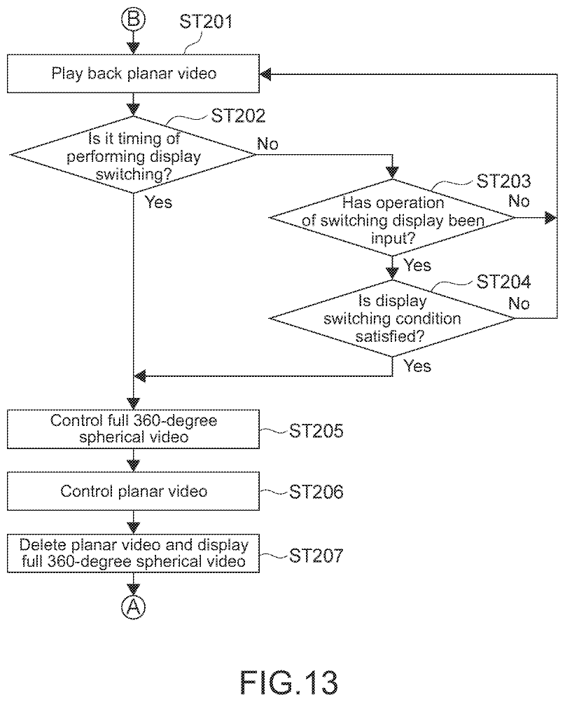

FIG. 12 is a flowchart illustrating an example of processing of display switching from the full 360-degree spherical video 61 to the planar video 62. FIG. 13 is a flowchart illustrating an example of processing of display switching from the planar video 62 to the full 360-degree spherical video 61.

As illustrated in FIG. 12, the full 360-degree spherical video 61 is played back by the HMD 10 (Step 101). In the present embodiment, the full 360-degree spherical video data 61 is read by the server apparatus 50, as illustrated in FIG. 4. Rendering processing is performed by the rendering section 59 on the basis of the read full 360-degree spherical video data 61, and rendering data is generated that is used to display the respective frame images 68 of the full 360-degree spherical video 61 on the display 22 of the HMD 10.

The generated rendering data for the full 360-degree spherical video 61 is transmitted to the HMD 10. On the basis of the rendering data transmitted from the server apparatus 50, the display control section 36 of the HMD 10 causes the full 360-degree spherical frame image 68 to be displayed on the display 22 at a specified frame rate. This enables the user 1 who is wearing the HMD 10 to view the full 360-degree spherical video 61.

Note that, on the basis of data of tracking detected by the tracking section 35, the position of the display region 67 displayed on the HMD 10 is moved according to the movement of the head of the user 1 (a change in the orientation of the HMD 10).

For example, the tracking data transmitted from the HMD 10 is received by the user interface 53 of the server apparatus 50. Then, a range (an angle of view) corresponding to the display region 67 of the display 22 of the HMD 10 is calculated by the section 57 for controlling a full 360-degree spherical video. Rendering data for the calculated range is generated to be transmitted to the HMD 10 by the rendering section 59. The display control section 36 of the HMD 10 displays the full 360-degree spherical video 61 on the display 22 on the basis of the transmitted rendering data.

Alternatively, the range to be displayed on the display 22 (the angle of view) may be determined by the display control section 36 of the HMD 10 on the basis of the tracking data.

It is determined, by the switching timing determination section 54, whether it is a timing of performing display switching processing (Step 102). The determination is performed on the basis of the metadata 63 output from the meta-parser 52. Specifically, on the basis of the switching timing included in the metadata 63c illustrated in FIG. 11, it is determined whether it is a timing of performing the display switching processing.

When it has been determined that it is not a timing of performing the display switching processing (No in Step 102), it is determined, by the switching determination section 56, whether an instruction to switch display has been input (Step 103). The determination is performed on the basis of an input instruction of the user 1 that is received by the user interface 53.

When the instruction to switch display has not been input (No in Step 103), the process returns to Step 101, and the full 360-degree spherical video 61 is continuously played back. When the instruction to switch display has been input (Yes in Step 103), it is determined, by the parallax determination section 55 and the switching determination section 56, whether a display switching condition for performing the display switching processing is satisfied (Step 104).

In the present embodiment, with respect to the display switching condition, it is determined whether a difference (parallax) in image-capturing position between the full 360-degree spherical video 61 and the planar video 62 is equal to or less than a specified threshold.

The parallax determination section 55 refers to the time series of a movement amount in the metadata 63c illustrated in FIG. 11. Then, the parallax determination section 55 determines whether a difference in image-capturing position between the full 360-degree spherical frame image 68 displayed on the HMD 10 and the planar frame image 64 captured at the same image-capturing time, is equal to or less than the specified threshold. Note that the planar frame image 64 captured at the same image-capturing time is a switching-target image. A result of the determination performed by the parallax determination section 55 is output to the switching determination section 56.

On the basis of the result the determination performed by the parallax determination section 55, the switching determination section 56 determines whether the display switching condition is satisfied. When the parallax between the full 360-degree spherical frame image 68 and the switching-target planar frame image 64 is equal to or less than the specified threshold, it is determined that the display switching condition is satisfied. When the parallax between the full 360-degree spherical frame image 68 and the switching-target planar frame image 64 is greater than the specified threshold, it is determined that the display switching condition is not satisfied.

When the display switching condition is not satisfied (No in Step 104), the process returns to Step 101, and the full 360-degree spherical video 61 is continuously played back. In this case, an error or the like indicating that the display switching processing is not allowed to be performed, may be notified to the user 1. When the display switching condition is satisfied (Yes in Step 104), the display switching processing is performed.

The display switching condition according to the present embodiment includes the condition that a difference in image-capturing position between the first real space image and the second real space image is equal to or less than a specified threshold. Further, the planar frame image 64 captured at the same image-capturing time as the full 360-degree spherical frame image 68 is set to be a switching-target image. Thus, in the present embodiment, it is also possible to consider that the display switching condition includes the condition that the image-capturing time of the first real space image and the image-capturing time of the second real space image are the same as each other.

Note that, with respect to frame images in which a difference in image-capturing time between the frame images is equal to or less than a specified threshold, it is also possible to set the frame images to be switching targets for each other. In this case, it is also possible to consider that the display switching condition includes the condition that a difference in image-capturing time between the first real space image and the second real space image is equal to or less than a specified threshold.

With respect to the display switching processing, the full 360-degree spherical video 61 is controlled by the section 57 for controlling a full 360-degree spherical video (Step 105). Further, the planar video 62 is controlled by the planar video control section 58 (Step 106). Steps 105 and 106 may be performed in parallel.

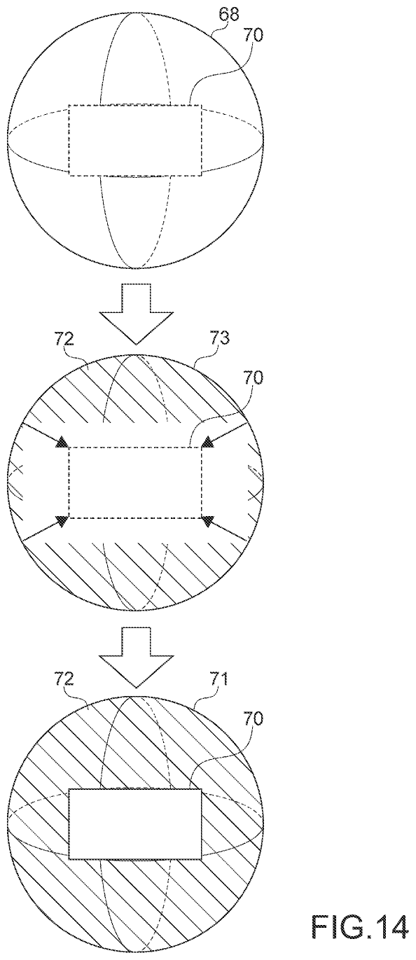

FIG. 14 is a schematic diagram for describing an example of controlling the full 360-degree spherical video 61. First, a corresponding range 70, from among the full 360-degree spherical frame image 68, that corresponds to an angle of view of the switching-target planar frame image 64 is calculated. It is possible to calculate the corresponding range 70 on the basis of, for example, the time series of an angle of view, the time series of an image-capturing direction, and the time series of rotation of the metadata 63c illustrated in FIG. 11.

A range other than the corresponding range 70 is masked by the section 57 for controlling a full 360-degree spherical video to generate a restriction image 71 in which display on the range (hereinafter referred to as a masking range 72) other than the corresponding range 70 is restricted. In the present embodiment, a transition image 73 in which masking is gradually performed on the corresponding range 70 from the outside is also generated together with the generation of the restriction image 71, as illustrated in FIG. 14.

Typically, a background image is selected as a masking image that is displayed on the masking range 72. In other words, the masking range 72 other than the corresponding range 70 in the full 360-degree spherical video 61 is masked with a background image displayed on a region other than the first display region R1 in the planar video 62. Note that the method for generating the transition image 73 in which masking is continuously expanded is not limited.

Further, in the present embodiment, the restriction image 71 is generated such that the display content displayed on the corresponding range 70 of the full 360-degree spherical frame image 68 is the same as the display content of the switching-target planar frame image 64.

The section 57 for controlling a full 360-degree spherical video can generate an image of any angle of view on the basis of the full 360-degree spherical video data 61. Thus, it is possible to generate the restriction image 71 in which the same display content as that of the planar frame image 64 is displayed on the corresponding range 70.

In this case, it is also possible to convert a projection method such that, for example, an image in the corresponding range 70 is a rectangular image captured using perspective projection, as in the case of the planar frame image 64. Note that, depending on the format for the full 360-degree spherical video 61, it may be possible to generate a rectangular image captured using perspective projection that is the same as the planar frame image 64, just by masking the masking range 72 other than the corresponding range 70.

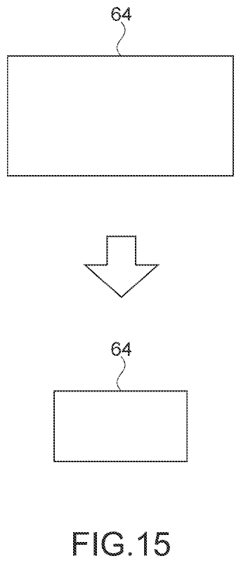

FIG. 15 is a schematic diagram for describing an example of controlling the planar video 62. The size of the switching-target planar frame image 64 is controlled by the planar video control section 58. Specifically, the size of the planar frame image 64 is controlled such that the planar frame image 64 has the size of the corresponding range 70 of the restriction image 71 illustrated in FIG. 14.

In the example illustrated in FIG. 15, the size of the planar frame image 64 is changed to be small. Of course, the control is not limited to this, and the size of the planar frame image 64 may be changed to be large. Further, there may be no need for a change in size.

Returning to FIG. 12, after the control of the full 360-degree spherical video 61 and the control of the planar video 62 are performed, the full 360-degree spherical video 61 is deleted, and the planar video 62 is displayed (Step 107).

In the present embodiment, rendering data for the transition image 73, the restriction image 71, and the planar frame image 64 of which the size has been controlled, is generated to be transmitted to the HMD 10 by the rendering section 59. An image (the transition image 73) in which the masking range 72 other than the corresponding range 70 in the full 360-degree spherical frame image 68 is gradually masked, is displayed by the display control section 36 of the HMD 10, and the restriction image 71 is displayed at the end by the display control section 36.

The planar frame image 64 of which the size has been controlled is displayed simultaneously with deletion of the restriction image 71. In other words, in the present embodiment, the display switching processing is performed to switch between display of the restriction image 71 and display of the planar frame image 64 of which the size has been controlled. Thus, switching is performed between display of the full 360-degree spherical video 61 and display of the planar video 62.

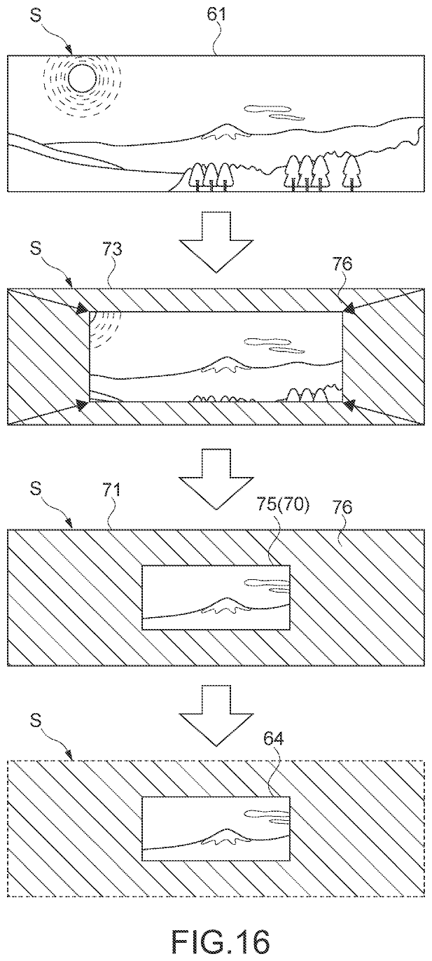

FIG. 16 schematically illustrates an example of how a video looks to the user 1 when display switching processing is performed. First, the full 360-degree spherical video 61 is displayed on the virtual space S. In FIG. 16, rectangular images are schematically displayed, but actually, experience of viewing surrounding the user 1 himself/herself is provided.

Next, masking is gradually performed from the outside toward a rectangular range 75 that is a portion of the full 360-degree spherical video 61. At the end, the entirety of a range 76 other than the rectangular range 75 that is a portion of the full 360-degree spherical video 61 is masked. The rectangular range 75 corresponds to the corresponding range 70 illustrated in FIG. 14. Further, the image in which masking is gradually expanded corresponds to the transition image 73. The image in which a range other than the rectangular range 70 is masked corresponds to the restriction image 71.

Note that, in the example illustrated in FIG. 16, the rectangular range 75 (the corresponding range 70) is situated in a center portion of a viewing range of the user 1. However, the corresponding range 70 may be situated offset from the center portion of the viewing range of the user 1, or the corresponding range 70 may be situated out of the viewing range of the user.

In such cases, for example, the full 360-degree spherical video 61 may be moved such that, for example, the corresponding range 70 is situated within the viewing range of the user 1 (such that, for example, the corresponding range 70 is moved to the center portion of the viewing range). Alternatively, the line of sight of the user 1 (the orientation of the HMD 10) may be guided such that the corresponding range 70 is situated within the viewing range (such that, for example, the corresponding range 70 is situated in the center portion of the viewing range). Moreover, any processing may be performed.

At the end, the planar frame image 64 of which the size has been controlled is displayed on the corresponding range 70 simultaneously with deletion of the restriction image 71. The display content of the corresponding range 70 of the restriction image 71 and the display content of the planar frame image 64 of which the size has been controlled are the same content. Further, the restriction image 71 is masked by a background image displayed when the planar frame image 64 is displayed.

Thus, when switching is performed from display of the restriction image 71 to display of the planar frame image 64, there is no change in how it looks to the user 1, that is, how it looks remains unchanged. In other words, it is possible to enjoy viewing content without being aware of a timing of switching from the full 360-degree spherical video 61 to the planar video 62.

Returning to FIG. 12, when it has been determined in Step 102 that it is a timing of performing the display switching processing, the display switching processing is performed. Typically, the display switching processing is performed at a timing determined by a creator of VR content. Thus, the full 360-degree spherical video 61 and the planar video 62 satisfying a switching condition are provided in advance, and the display switching processing is naturally performed.

The processing of display switching from the planar video 62 to the full 360-degree spherical video 61 is described. As illustrated in FIG. 13, the planar video 62 is played back by the HMD 10 (Step 201). In the present embodiment, the planar video data 62 is read by the server apparatus 50. Rendering data for the respective frame images 64 of the planar video 62 is generated by the rendering section 59 on the basis of the read planar video data 62.

On the basis of the rendering data transmitted from the server apparatus 50, the display control section 36 of the HMD 10 causes the planar frame image 64 to be displayed on the display 22 at a specified frame rate. This enables the user 1 who is wearing the HMD 10 to view the planar video 62.

It is determined, by the switching timing determination section 54, whether it is a timing of performing display switching processing (Step 202). When it has been determined that it is not a timing of performing the display switching processing (No in Step 202), it is determined, by the switching determination section 56, whether an instruction to switch display has been input (Step 203).

When the instruction to switch display has not been input (No in Step 203), the process returns to Step 201, and the planar video 62 is continuously played back. When the instruction to switch display has been input (Yes in Step 203), it is determined, by the parallax determination section 55 and the switching determination section 56, whether a display switching condition for performing the display switching processing is satisfied (Step 204).

When the display switching condition is not satisfied (No in Step 204), the process returns to Step 201, and the planar video 62 is continuously played back. When the display switching condition is satisfied (Yes in Step 204), the display switching processing is performed. The display switching condition is the same as the condition determined when the processing of display switching from the full 360-degree spherical video 61 to the planar video 62 is performed.

With respect to the display switching processing, the full 360-degree spherical video 61 is controlled by the section 57 for controlling a full 360-degree spherical video (Step 205). Further, the planar video 62 is controlled by the planar video control section 58 (Step 206). Steps 205 and 206 may be performed in parallel.

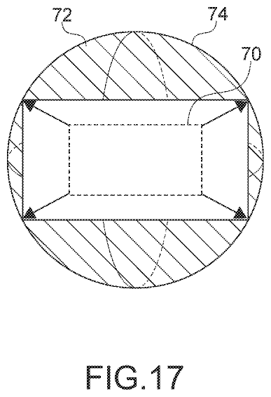

The restriction image 71 illustrated in FIG. 14 is generated by the section 57 for controlling a full 360-degree spherical video. Further, a transition image 74 in which masking performed on the masking range 72 other than the corresponding range 70 is gradually decreased outwardly is generated, as illustrated in FIG. 17. The transition image 74 can also be considered an image in which the display range of the full 360-degree spherical video 61 is gradually expanded.

Note that the method for generating the transition video 74 is not limited, the method being performed to continuously remove masking and to display the full 360-degree spherical video 61 at the end. With respect to an angle of view of 180 degrees or more, it is possible to continuously expand the angle of view by not displaying a range that is situated on the opposite side and corresponds to an angle of view obtained by subtracting 180 degrees or more from 360 degrees. This results in a full 360-degree spherical display.

The size of the planar frame image 64 is controlled by the planar video control section 58 such that the planar frame image 64 has the size of the switching-target corresponding range 70 of the restriction image 71 (refer to FIG. 15). After the control of the full 360-degree spherical video 61 and the control of the planar video 62 are performed, the planar video 62 is deleted, and the full 360-degree spherical video 61 is displayed (Step 207).

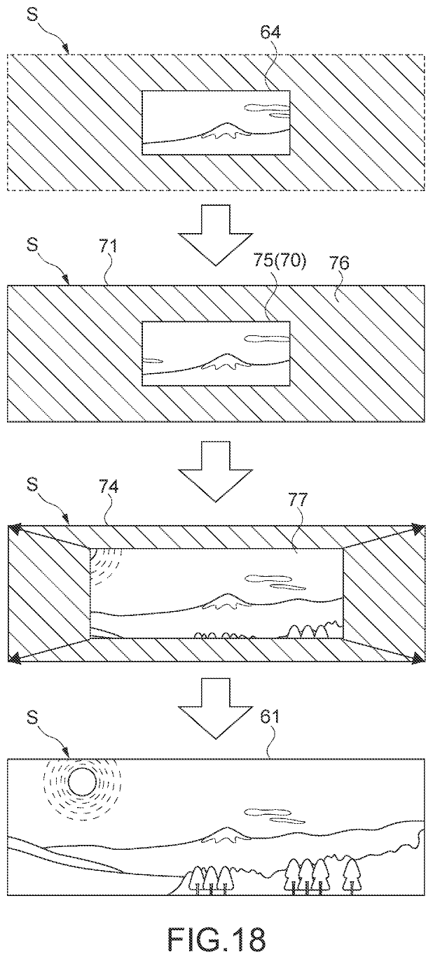

FIG. 18 schematically illustrates an example of how a video looks to the user 1 when display switching processing is performed. First, the size of the planar frame image 64 displayed on the virtual space S is controlled. Then, the restriction image 71 is displayed simultaneously with deletion of the planar frame image 64.

The display content of the planar frame image 64 of which the size has been controlled and the display content of the rectangular range 75 (the corresponding range 70) of the restriction image 71 are the same content. Further, the restriction image 71 is masked by a background image displayed when the planar frame image 64 is displayed.

Thus, when switching is performed from display of the planar frame image 64 to display of the restriction image 71, there is no change in how it looks to the user 1, that is, how it looks remains unchanged. Thus, the user 1 does not recognize switching from the planar video 62 to the full 360-degree spherical video 61, and, for the user 1, the planar frame image 64 is displayed.

A range 77 on which an image is displayed is gradually expanded outwardly (masking is gradually decreased), and the full 360-degree spherical video 61 is displayed at the end. This corresponds to the display of the transition image 74 and the display of the full 360-degree spherical video 61 illustrated in FIG. 17. As described above, the present embodiment enables the user 1 to enjoy viewing content without being aware of a timing of switching from the planar video 62 to the full 360-degree spherical video 61.

Returning to FIG. 13, when it has been determined in Step 202 that it is a timing of performing the display switching processing, the display switching processing is performed. Typically, the display switching processing is performed at a timing determined by a creator of VR content. Thus, the full 360-degree spherical video 61 and the planar video 62 satisfying a switching condition are provided in advance, and the display switching processing is naturally performed.

As described above, in the VR providing system 100 according to the present embodiment, display switching processing corresponding to an angle of view of the planar video 62 is performed on the basis of the metadata 63 related to display switching, and switching is performed between display of the planar video 62 and display of the full 360-degree spherical video 61. This makes it possible to continuously perform transition between display of the full 360-degree spherical video 61 and display of the planar video 62. This results in being able to provide the user 1 with a high-quality viewing experience.

The full 360-degree spherical video 61 viewed using the HMD 10 extends across the field of view, and has a direct link to a sense of sight. Thus, when editing is performed that is used for a video (the planar video 62) that is captured in a rectangular shape using perspective projection and used to conventionally perform broadcasting on television or the like, the user 1 may be adversely affected such as getting sickness. Thus, it is often the case that the method for creating content is restricted.

Thus, the inventors have newly devised partially using the planar video 62 even in content of the full 360-degree spherical video 61. However, the inventors have also found out that there is a problem in which, when display is suddenly switched, the user 1 does not feel the continuity of space and time and recognizes the content as separate and independent pieces of content. The inventors have also discussed this point.

As a result of the discussion, the inventors have newly devised the display switching processing according to the present technology. In other words, switching is continuously performed between the planar video 62 and the full 360-degree spherical video 61 such that the display content of the corresponding range 70 and the display content of the planar video 62 look the same. Then, switching is performed between the planar video 62 and the full 360-degree spherical video 61 when the display content of the corresponding range 70 and the display content of the planar video 62 look the same. This enables the user 1 to recognize the content as one content without the continuity of space and time being lost.

Further, the present technology makes it possible to temporarily use the planar video 62 in order to overcome restrictions caused in the full 360-degree spherical video 61. This results in being able to provide VR content that makes it possible to have an experience with a sense of immersion into the full 360-degree spherical video 61 and various representations of the planar video 62 at the same time.

The following are examples of the restriction caused when the full 360-degree spherical video 61 is displayed.

(Restriction on Image-Capturing Position)

When the movement of a point of view in the virtual space S is represented using the full 360-degree spherical video 61, there is a need to capture the plurality of real space images 66 illustrated in FIG. 7 while moving the image-capturing position, so that the full 360-degree spherical video data 61 in which the image-capturing position is continuously moved is generated. In this case, it is very difficult to generate the full 360-degree spherical video 61 in which an impact due to hand-induced shake is suppressed.

Currently, it is possible to correct a hand induced-shake around 3 axes using software. Thus, there exists a full 360-degree spherical camera including such a function, but there is a need to perform cancelation using an external apparatus when correction is performed along 3 axes.

Thus, it is difficult to suppress an impact due to hand-induced shake, and the user 1 who is viewing the full 360-degree spherical video 61 gets sickness very easily. Further, visual information and sensation in the three semicircular canals easily get out of synchronization due to movement in the full 360-degree spherical video 61. The user 1 also gets sickness easily in this regard.

In order to overcome such restrictions, switching is performed from the full 360-degree spherical video 61 to the planar video 62 when the movement in the virtual space S is represented. Then, a moving image in which the point of view is moved along a movement route is displayed. The use of the planar video 62 makes it possible to sufficiently suppress an impact due to hand-induced shake during performing image-capturing. Further, a usual, familiar moving image is obtained. Thus, it is possible to sufficiently prevent visual information and sensation in the three semicircular canals from getting out of synchronization. This results in being able to sufficiently prevent the user 1 who is viewing VR content from getting sickness, and to represent a smooth movement of a point of view.

(Restriction on Edition)

It is difficult to apply an ordinary video representation using, for example, panning, cutting, and a camera dolly.

For example, when panning or the like is performed with respect to the full 360-degree spherical video 61, sickness due to visual information and sensation in the three semicircular canals getting out of synchronization, is easily caused.

It is difficult to provide video representation obtained by controlling an angle of view.

It is the user 1 who determines a viewing-target point in the full 360-degree spherical video 61 and the size of a gazing-target region of the full 360-degree spherical video 61. Thus, it is difficult to provide representation obtained by controlling an angle of view such that a region or the like caused to attract attention from the user 1 is emphasized to be displayed.

It is difficult to display additional information such as subtitles.

It is difficult to clearly grasp where in the full 360-degree spherical video 61 additional information is displayed.

It is difficult to provide representation using special effects.

For example, if an effect such as intensive blinking is added to the full 360-degree spherical video 61, this may result in a burden on the user 1.

With respect to such restrictions, appropriate switching from the full 360-degree spherical video 61 to the planar video 62 makes it possible to perform free edition such as switching of a cut or the like, a change in image size, a change in angle of view, display of additional information, and representation using special effects. This makes it possible to provide the user 1 with a high-quality viewing experience.

For example, when a scene is changed to another place or the like in VR content, a video of the other place or the like is displayed after switching to the planar video 62 is performed. It is possible to apply an effect of switching to a proven (familiar) scene in the planar video 62, and to provide various representation. Further, it is possible to suppress a burden on the user 1. Of course, the present technology is also applicable to switching from the planar video 62 to a video of another source such as another CG video.

(Restriction on Utilization of Asset)

Compared to the planar video 62, the technology for generating the full 360-degree spherical video 61 has been relatively recently developed. Thus, it is often the case that there is less accumulation of asset such as a video in the past for the full 360-degree spherical video 61, compared to the planar video 62. The full 360-degree spherical video 61 is switched to the planar video 62 in VR content as appropriate. This makes it possible to fully utilize asset such as a video in the past for the planar video 62. This results in being able to improve the quality of VR content, and thus to provide the user 1 with a high-quality viewing experience.

An example of a use case of the VR providing system 100 according to the present embodiment is described below.

Viewing of VR content of, for example, watching of sports and watching of a concert is an example of the use case. For example, a thumbnail used for content selection is displayed using the planar video 62. The use of the planar video 62 makes it possible to easily generate a plurality of thumbnails having the same size and the same shape.

When the content of watching of sports is selected by the user 1, a game highlight and the like are displayed using the planar video 62. Further, a moving image in which a point of view is moved from an entrance of a stadium until the user 1 sits on a seat of a stand, is displayed. The use of the planar video 62 makes it possible to easily display, for example, a video related to a game in the past and a video related to a player. Further, it is possible to represent a smooth movement of a point of view.

At a timing at which the user 1 sits on the seat, display switching processing is performed to display the full 360-degree spherical video 61 enabling the user to view the entire stadium. For example, a timing of sitting on a seat or the like is stored as the switching timing of the metadata 63c illustrated in FIG. 11. Of course, it is also possible for the user 1 to input an instruction to perform display switching processing while the planar video 62 is being played back. When the display switching condition is satisfied, the full 360-degree spherical video 61 enabling the user to view the entire stadium from a point at which the instruction is input, is displayed. This makes it possible to obtain a viewing experience that provides a considerably great sense of immersion and a sense of realism.

When the content of watching of a concert is selected by the user 1, a video for introducing an artist and a video of a concert in the past are displayed using the planar video 62. Further, a moving image in which a point of view is moved from an entrance of a concert hall until the user 1 sits on an auditorium seat, is displayed.

At a timing at which the user 1 sits on the seat, display switching processing is performed to display the full 360-degree spherical video 61 enabling the user to view the entire concert hall. Of course, the full 360-degree spherical video 61 may be displayed by an instruction to perform display switching processing being input by the user 1. This enables the user 1 to fully enjoy the concert, and to obtain a high-quality viewing experience.

Viewing of travel content is another example of the use case. For example, the full 360-degree spherical video 61 is displayed at an entrance of a mountain trail. This enables the user 1 to enjoy nature while viewing the complete 360 degrees circumference of the user 1. Then, at a timing at which the user 1 starts walking along the mountain trail to the top of the mountain, switching to the planar video 62 is performed, and the point of view is moved. For example, a timing after a specified period of time has elapsed since the arrival at the entrance is stored as the switching timing of the metadata 63c illustrated in FIG. 11. Alternatively, the intention of departure of the user 1 may be input, and display switching processing may be performed according to the input.

The use of the planar video 62 results in a smooth movement of a point of view along the mountain trail. Thereafter, the full 360-degree spherical video 61 is automatically displayed at a timing of arriving at an intermediate point on the way or the top of the mountain. This enables user 1 to enjoy nature while viewing the complete 360 degrees circumference of the user 1 at the intermediate point or the top of the mountain.

Of course, it is also possible for the user 1 to input an instruction to perform display switching processing in the middle of the mountain trail. When the display switching condition is satisfied, the full 360-degree spherical video 61 at a point at which the instruction is input is displayed. This makes it possible to obtain a viewing experience that provides a considerably great sense of immersion and makes the user 1 feel like he/she is really in a mountain. Moreover, the present technology is applicable to viewing of various VR content.

FIG. 19 is a block diagram illustrating an example of a configuration of hardware of the server apparatus 50.

The server apparatus 50 includes a CPU 501, a ROM 502, a RAM 503, an input/output interface 505, and a bus 504 through which these components are connected to each other. A display section 506, an operation section 507, a storage 508, a communication section 509, a drive 510, and the like are connected to the input/output interface 505.

The display section 506 is a display device using, for example, liquid crystal or electroluminescence (EL). Examples of the operation section 507 include a keyboard, a pointing device, a touch panel, and other operation apparatuses. When the operation section 507 includes a touch panel, the touch panel may be integrated with the display section 506.

The storage 508 is a nonvolatile storage device, and examples of the storage 508 include a hard disk drive (HDD), a flash memory, and other solid-state memories. The drive 510 is a device that is capable of driving a removable recording medium 511 such as an optical recording medium, a magnetic recording tape, or the like. Any non-transitory computer-readable storage medium may be used as the recording medium 511.

The communication section 509 is a communication module used to communicate with another device through a network such as a local area network (LAN) or a wide area network (WAN). A communication module used to perform near-field communication, such as Bluetooth, may be provided. Further, communication equipment such as a modem or a router may be used.

Information processing performed by the server apparatus 50 having the configuration of hardware described above is performed by software stored in, for example the storage 508 or the ROM 502, and hardware resources of the server apparatus 50 working cooperatively. Specifically, the information processing is performed by the CPU 501 loading, into the RAM 503, a program included in the software and stored in the storage 508, the ROM 502, or the like and executing the program.

### Other Embodiments

The present technology is not limited to the embodiments described above, and can achieve various other embodiments.

The example in which switching is performed between display of a full 360-degree spherical frame image and display of a planar frame image has been described above. Without being limited thereto, switching may be performed between display of a full 360-degree spherical image formed of a still image and display of a planar video formed of a moving image. For example, it is also possible to perform display switching processing including switching between display of a final frame image of a specified planar video and display of a full 360-degree spherical image. Note that the present technology is also applicable to switching between display of a full 360-degree spherical video formed of a moving image and display of a planar image that is a still image, or to display switching between still images.

The fact that the technology disclosed in Patent Literature 1 (Japanese Patent Application Laid-Open No. 2018-11302) is applicable to calculation of the metadata 63c, has been described above. Moreover, the use of the technology disclosed in Patent Literature 1 (Japanese Patent Application Laid-Open No. 2018-11302) makes it possible to align a full 360-degree spherical video with a planar video, and to calculate a corresponding range.

The full 360-degree spherical video has been described above as an example of the second real space image. Without being limited thereto, a panoramic video or the like that makes it possible to display a range that is a portion of the complete 360 degrees circumference may be generated as the second real space image. For example, the present technology is applicable to switching between display of a planar video that is the first real space image, and display of the panoramic image.

In other words, the present technology is applicable to the case in which any image displayed on a region that includes a region, in a virtual space, on which the first real space image is displayed, is adopted as the second real space image, the region on which the second real space image is displayed being larger than the region on which the first real space image is displayed. For example, it is possible to adopt, as the second real space image, a video of an arbitrary field of view of, for example, 180 degrees, which is not 360 degrees if the video is displayed on a larger region that makes it possible to provide a greater sense of immersion, compared to the case of a planar video.

The first real space image is not limited to a planar video. For example, any image displayed on a region that is included in a display region of the second real space image and is smaller than the display region, can be adopted as the first real space image. For example, a panoramic video may be used as the first real space image, in which a display region of the panoramic video is smaller than the display region of a full 360-degree spherical video that is the second real space image.

The example in which a restriction image is generated such that the display content of a corresponding range of a full 360-degree spherical video and the display content of a planar video are the same content, has been described above. Here, an expression such as “the same content” may include not only an expression such as “exactly the same content” in concept, but also an expression such as “substantially the same content” in concept. Images captured from substantially the same image-capturing position at substantially the same timing are included in images having the same display content.

The function of the server apparatus illustrated in FIG. 4 may be included in the HMD. In this case, the HMD serves as an embodiment of the information processing apparatus according to the present technology. Further, a display apparatus used to display VR content is not limited to the immersive HMD illustrated in FIG. 1. Any other display apparatus that is capable of representing VR may be used.

The example in which the server apparatus is an embodiment of the information processing apparatus according to the present technology, has been described above. However, the information processing apparatus according to the present technology may be implemented by any computer that is provided separately from the server apparatus and connected to the server apparatus by wire or wirelessly. For example, the information processing method according to the present technology may be performed by the server apparatus and another computer operating cooperatively.

In other words, the information processing method and the program according to the present technology can be performed not only in a computer system formed of a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both a case in which the acquisition of the first and second real space images, the acquisition of metadata, display switching processing, and the like are executed by a single computer; and a case in which the respective processes are executed by different computers. Further, the execution of each process by a specified computer includes causing another computer to execute a portion of or all of the process and acquiring a result of it.

In other words, the information processing method and the program according to the present technology are also applicable to a configuration of cloud computing in which a single function is shared and cooperatively processed by a plurality of apparatuses through a network.

The respective configurations of the HMD, the server apparatus, and the like; the flow of the display switching processing; and the like described with reference to the respective figures are merely embodiments, and any modifications may be made thereto without departing from the spirit of the present technology. In other words, for example, any other configurations or algorithms for purpose of practicing the present technology may be adopted.

In the present disclosure, expressions such as “the same” and “identical” may respectively include not only expressions such as “exactly the same” and “exactly identical” in concept, but also expressions such as “substantially the same” and “substantially identical” in concept. For example, the expressions such as “the same” and “identical” also respectively include specified ranges in concept, with the expressions such as “exactly the same” and “exactly identical” being respectively used as references.

At least two of the features of the present technology described above can also be combined. In other words, various features described in the respective embodiments may be combined discretionarily regardless of the embodiments. Further, the various effects described above are not limitative but are merely illustrative, and other effects may be provided.

Note that the present technology may also take the following configurations.

(1) An information processing apparatus, including

a processor that switches between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

(2) The information processing apparatus according to (1), in which

on the basis of the metadata, the processor determines whether the time has come to perform the switching processing, and

the processor performs the switching processing when the time has come to perform the switching processing.

(3) The information processing apparatus according to (1) or (2), in which

on the basis of the metadata, the processor determines whether a switching condition for performing the switching processing is satisfied, and

the processor performs the switching processing when the switching condition is satisfied.

(4) The information processing apparatus according to (3), in which

the switching condition includes a condition that a difference in image-capturing position between the first real space image and the second real space image is equal to or less than a specified threshold.

(5) The information processing apparatus according to (3) or (4), in which

the switching condition includes a condition that a difference in image-capturing time between the first real space image and the second real space image is equal to or less than a specified threshold.

(6) The information processing apparatus according to any one of (1) to (5), in which

the switching processing includes
generating a restriction image in which display on a range other than a corresponding range in the second real space image is restricted, the corresponding range corresponding to the angle of view of the first real space image, and
switching between the display of the first real space image and display of the restriction image.
   (7) The information processing apparatus according to (6), in which

the switching processing includes
changing a size of the first real space image such that the first real space image has a size of the corresponding range in the second real space image, and
then switching between the display of the first real space image and the display of the restriction image.
   (8) The information processing apparatus according to (6) or (7), in which

the switching processing includes generating the restriction image such that display content displayed on the corresponding range in the restriction image and display content of the first real space image are the same display content.

(9) The information processing apparatus according to any one of (1) to (8), in which

the first real space image is an image captured from a specified image-capturing position in a real space.

(10) The information processing apparatus according to any one of (1) to (9), in which

the second real space image is an image obtained by combining a plurality of images captured from a specified image-capturing position in a real space.

(11) The information processing apparatus according to any one of (1) to (10), in which

the second real space image is a full 360-degree spherical image.

(12) The information processing apparatus according to any one of (1) to (11), in which

the first real space image is a moving image including a plurality of frame images, and

the processor switches between display of a specified frame image from among the plurality of frame images of the first real space image and the display of the second real space image.

(13) The information processing apparatus according to (12), in which

the second real space image is a moving image including a plurality of frame images, and

the processor switches between the display of the specified frame image of the first real space image and display of a specified frame image from among the plurality of frame images of the second real space image.

(14) The information processing apparatus according to any one of (1) to (13), in which

the metadata includes information regarding the angle of view of the first real space image.

(15) The information processing apparatus according to any one of (1) to (14), in which

the metadata includes first image-capturing information including an image-capturing position of the first real space image, and second image-capturing information including an image-capturing position of the second real space image.

(16) The information processing apparatus according to (15), in which

the first image-capturing information includes an image-capturing direction and an image-capturing time of the first real space image, and

the second image-capturing information includes an image-capturing time of the second real space image.

(17) The information processing apparatus according to any one of (1) to (16), in which

the metadata includes information regarding a timing of performing switching processing.

(18) The information processing apparatus according to any one of (1) to (17), in which

the processor controls the display of the first real space image and the display of the second real space image on a head-mounted display (HMD).

(19) An information processing method that is performed by a computer system, the information processing method including

switching between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

(20) A program that causes a computer system to perform a process including

switching between display of a first real space image and display of a second real space image by performing switching processing on the basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

### REFERENCE SIGNS LIST

R1 first display region
R2 second display region

### 10 HMD

22 display
24 operation button
25 communication section
28 controller
50 server apparatus
53 user interface
54 switching timing determination section
55 parallax determination section
56 switching determination section
57 section for controlling full 360-degree spherical video
58 planar video control section
59 rendering section
60 database
61 full 360-degree spherical video data (full 360-degree spherical video)
62 planar video data (planar video)
63 metadata
64 planar frame image
66 real space image
68 full 360-degree spherical frame image
70 corresponding range
71 restriction image
100 VR providing system

1. An information processing apparatus, comprising
a processor that switches between display of a first real space image and display of a second real space image by performing switching processing on a basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

2. The information processing apparatus according to claim 1, wherein
on the basis of the metadata, the processor determines whether the time has come to perform the switching processing, and
the processor performs the switching processing when the time has come to perform the switching processing.

3. The information processing apparatus according to claim 1, wherein
on the basis of the metadata, the processor determines whether a switching condition for performing the switching processing is satisfied, and
the processor performs the switching processing when the switching condition is satisfied.

4. The information processing apparatus according to claim 3, wherein
the switching condition includes a condition that a difference in image-capturing position between the first real space image and the second real space image is equal to or less than a specified threshold.

5. The information processing apparatus according to claim 3, wherein
the switching condition includes a condition that a difference in image-capturing time between the first real space image and the second real space image is equal to or less than a specified threshold.

6. The information processing apparatus according to claim 1, wherein
the switching processing includes
generating a restriction image in which display on a range other than a corresponding range in the second real space image is restricted, the corresponding range corresponding to the angle of view of the first real space image, and
switching between the display of the first real space image and display of the restriction image.

7. The information processing apparatus according to claim 6, wherein
the switching processing includes
changing a size of the first real space image such that the first real space image has a size of the corresponding range in the second real space image, and
then switching between the display of the first real space image and the display of the restriction image.

8. The information processing apparatus according to claim 6, wherein
the switching processing includes generating the restriction image such that display content displayed on the corresponding range in the restriction image and display content of the first real space image are the same display content.

9. The information processing apparatus according to claim 1, wherein
the first real space image is an image captured from a specified image-capturing position in a real space.

10. The information processing apparatus according to claim 1, wherein
the second real space image is an image obtained by combining a plurality of images captured from a specified image-capturing position in a real space.

11. The information processing apparatus according to claim 1, wherein
the second real space image is a full 360-degree spherical image.

12. The information processing apparatus according to claim 1, wherein
the first real space image is a moving image including a plurality of frame images, and
the processor switches between display of a specified frame image from among the plurality of frame images of the first real space image and the display of the second real space image.

13. The information processing apparatus according to claim 12, wherein
the second real space image is a moving image including a plurality of frame images, and
the processor switches between the display of the specified frame image of the first real space image and display of a specified frame image from among the plurality of frame images of the second real space image.

14. The information processing apparatus according to claim 1, wherein
the metadata includes information regarding the angle of view of the first real space image.

15. The information processing apparatus according to claim 1, wherein
the metadata includes first image-capturing information including an image-capturing position of the first real space image, and second image-capturing information including an image-capturing position of the second real space image.

16. The information processing apparatus according to claim 15, wherein
the first image-capturing information includes an image-capturing direction and an image-capturing time of the first real space image, and
the second image-capturing information includes an image-capturing time of the second real space image.

17. The information processing apparatus according to claim 1, wherein
the metadata includes information regarding a timing of performing switching processing.

18. The information processing apparatus according to claim 1, wherein
the processor controls the display of the first real space image and the display of the second real space image on a head-mounted display (HMD).

19. An information processing method that is performed by a computer system, the information processing method comprising
switching between display of a first real space image and display of a second real space image by performing switching processing on a basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.

20. A program that causes a computer system to perform a process comprising
switching between display of a first real space image and display of a second real space image by performing switching processing on a basis of metadata related to the switching between the display of the first real space image and the display of the second real space image, the switching processing corresponding to an angle of view of the first real space image, the first real space image being displayed on a virtual space, the second real space image being displayed on a region including a region, in the virtual space, on which the first real space image is displayed, the region on which the second real space image is displayed being larger than the region on which the first real space image is displayed.
